(19) United States
(12) Patent Application Publication
(10) Pub. No.: US 2007/0157148 A1
(43) Pub. Date: Jul. 5, 2007

(54) Circuit layout system for automatically indicating items to wait for modification and method thereof

(75) Inventors: Yu-Chuan Chang, Taipei (TW); Chang-Chin Lai, Taipei (TW); Ya-Hsun Hsu, Taipei (TW); Shu-Fen Tsai, Taipei (TW)

Correspondence Address: BIRCH STEWART KOLASCH & BIRCH, PO BOX 747, FALLS CHURCH, VA, 22040-0747, US

(73) Assignee: INVENTEC CORPORATION

(21) Appl. No.: 11/638,425

(22) Filed: Dec. 14, 2006

(30) Foreign Application Priority Data
Dec. 16, 2005 (TW) 094144898

(51) Int. Cl. G06F 17/50

(52) U.S. Cl. 716/11; 716/4

(57) ABSTRACT

A circuit layout system for automatically indicating items to wait for modified and method thereof are provided, wherein a set of items to wait for modified recorded on an amendment list is stored on the circuit layout software; the set of items to wait for modified is compared with the circuit diagram via the circuit layout software to indicate to the user the number of items to wait for modified; parts that need to be modified are indicated to the user during modification, such that automatic indication of the items to wait for modified can be achieved, thus avoiding the circumstance that some items to wait for modified are not modified completely due to the negligence of the user.

### CROSS-REFERENCE TO RELATED APPLICATIONS

This non-provisional application claims priority under 35 U.S.C. § 119(a) on patent application Ser. No(s). 094144898 filed in Taiwan, R.O.C. on Dec. 16, 2005, the entire contents of which are hereby incorporated by reference.

### BACKGROUND OF THE INVENTION

1. Field of Invention

The present invention relates to a circuit layout system and method thereof, and more particularly to a system and method suitable for being applied to a piece of circuit layout software, which is used for automatically indicating to the user items to wait for modified by comparing a set of items to wait for modified with the circuit diagram on the circuit layout software.

2. Related Art

Before the printed circuit board came out, electronic elements were directly connected through electrical wires. In the year of 1948, the printed circuit board technique was transferred from military application to commercial application in the U.S.A., and it has been widely used since the mid 50's of the twentieth century. Till now, circuit breadboards implemented by being directly connected with electrical wires only function as an effective tool for experimentation; whereas the printed circuit board has occupied the dominant position in the electronics industry.

The printed circuit board is designed on the basis of the circuit diagram to achieve the functions as desired by the circuit designer. The design of the printed circuit board mainly refers to the layout design, and lots of internal and external factors should be considered. An excellent layout design can save manufacturing costs and achieve excellent circuit performance and heat dissipating performance. Simple layout design can be achieved manually, whereas complicated layout design is achieved through computer aided design.

Computer aided design simulates the real object by employing computer software, for revealing the features of newly developed products, such as configuration, structure, color, and texture. It involves both software and specific hardware. With the development of this technique, computer aided design can now be applied to a wide scope, comprising construction design diagrams, mechanical diagrams, circuit diagrams, and various other forms for exchanging designs.

The current computer aided design software of the circuit diagram only has the functions of designing and simulating the circuit diagram. But, in practice, other requests such as the requirements from the customers will be continuously added from the beginning of designing the circuit board till the printing procedure, such that the designer must make continuous modifications to the designed circuit diagram. However, the current computer aided design software of the circuit diagram does not provide a corresponding function to accommodate such a requirement. Therefore, during the modification process, after the amendment lists in forms of written files, oral messages, or E-mail, etc. are obtained by the designer, human negligence always occurs during the comparison between the modified items with those on the amendment lists, such that the modifications to the designed circuit diagram will have not been performed completely, causing troubles in the subsequent processes.

### SUMMARY OF THE INVENTION

In view of the above problem, a main object of the present invention is to provide a system and a method thereof suitable for being applied to the circuit layout software, which are used for automatically indicating to the user items to wait for modified by comparing a set of items to wait for modified with the circuit diagram on the circuit layout software. The items to wait for modified stored in the software are read by executing the executable program on the circuit layout software; and the parts of the circuit diagram on the circuit layout software to be modified are searched according to the modification information recorded in the items to wait for modified; finally, the parts to be modified are marked for the user, such that the object of automatically indicating the items to wait for modified can be achieved, thereby avoiding the circumstance that a given item to wait for modified has not been modified, and avoiding the subsequent problems caused thereby.

To achieve the above object, both the method and system can be employed according to the present invention. The system disclosed in the present invention comprises a data storage module, a display module, and an amendment check module. And the method disclosed in the present invention comprises the following steps: first of all, reading and displaying the items to wait for modified; selecting and modifying one item to wait for modified from the readout items to wait for modified; marking the parts to be modified in the items to wait for modified, according to the modification information recorded in the selected item to wait for modified; checking the item to wait for modified to see whether it has been modified or not after finishing the modification of the item to wait for modified, if no, generating a modification information of the part having not been modified, and indicating the part according to the generated modification information; checking all readout items to wait for modified to see whether or not there is any item has not been modified yet after the modification of the item to wait for modified has finished, and if yes, displaying the items to wait for modified but having not been modified completely for the next selection.

Furthermore, the system disclosed in the present invention further comprises an analysis transformation module and a modification suggestion module to generate additional functions. The method for generating additional functions comprises the following steps: inputting the amendment list; analyzing the input amendment list for generating and storing the items to wait for modified; displaying the suggested modification method while marking the parts to be modified in the items to wait for modified.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and which thus is not limitative of the present invention, and wherein:

FIG. 1 is a systematic organization diagram of a circuit layout system for automatically indicating the items to wait for modified and the method thereof according to the present invention;

FIG. 2a is a main flow chart of the circuit layout system for automatically indicating the items to wait for modified and the method thereof according to the present invention;

FIG. 2b is a flow chart of the examining of the circuit layout system for automatically indicating the items to wait for modified and the method thereof according to the present invention;

FIG. 3a is a diagram of a list of 3 items to wait for modified according to a first embodiment of the present invention;

FIG. 3b is a diagram of the list of 3 items to wait for modified with one item already having been modified according to the first embodiment of the present invention;

FIG. 4 is a diagram of a first resistor to be modified marked by a dashed frame according to the first embodiment of the present invention;

FIG. 5a is a diagram of a second resistor and a third resistor to be modified marked by dashed frames according to the first embodiment of the present invention;

FIG. 5b is a diagram of the third resistor to be modified marked by a dashed frame again according to the first embodiment of the present invention;

FIG. 6a is a diagram of a list of two items to wait for modified according to a second embodiment of the present invention;

FIG. 6b is a diagram of the list of two items to wait for modified with one item already having been examined according to the second embodiment of the present invention;

FIG. 7 is a diagram of a fourth resistor to be modified marked by a dashed frame with the modification suggestion being displayed; and

FIG. 8 is a diagram of the difference between before and after the modification of the fourth resistor marked by a dashed frame.

### DETAILED DESCRIPTION OF THE INVENTION

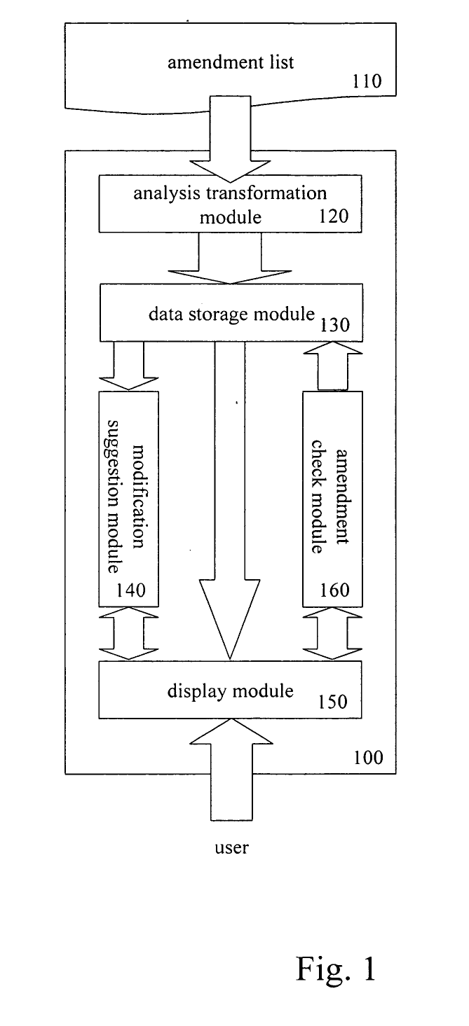

The anticipated objects can be achieved in the present invention through two parts, system and method. First, the systematic operation of the present invention is illustrated through FIG. 1, which is an organization diagram of a system for automatically indicating items to wait for modified according to the present invention.

As shown in FIG. 1, the system of the present invention comprises a data storage module 130, a display module 150, and an amendment check module 160, and the other parts will be mentioned later. The data storage module 130 is used for storing the items to wait for modified. The display module 150 is used for reading the items to wait for modified from the data storage module 130 and displaying them; selecting one item to wait for modified from the readout items to wait for modified; marking the parts that need to be modified according to the modification information recorded in the item to wait for modified; sending the modification information of the item to wait for modified to the amendment check module 160; receiving the modification information of a part having not been modified completely by the amendment check module 160; marking the part according to the modification information; and checking whether there is any part in the items to wait for modified readout from the data storage module 130 not to be modified yet. The amendment check module 160 is used for receiving the modification information of an item to wait for modified from the display module 150; checking whether the item to wait for modified has been completely modified yet or not according to the modification information; and sending a modification information of the part having not been modified into the display module 150 when the item to wait for modified has not been modified completely.

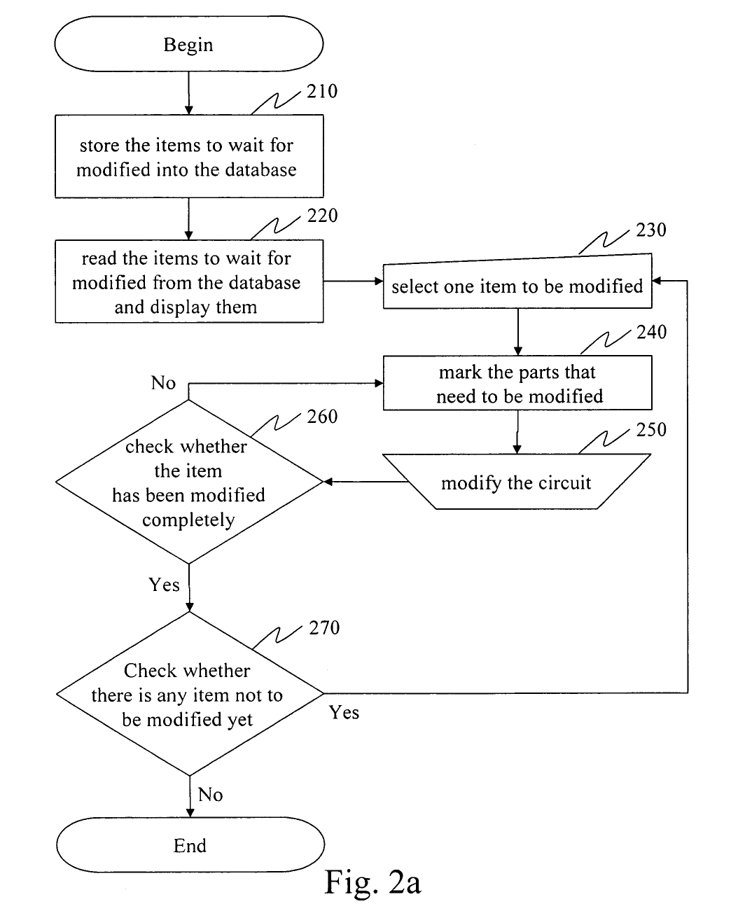

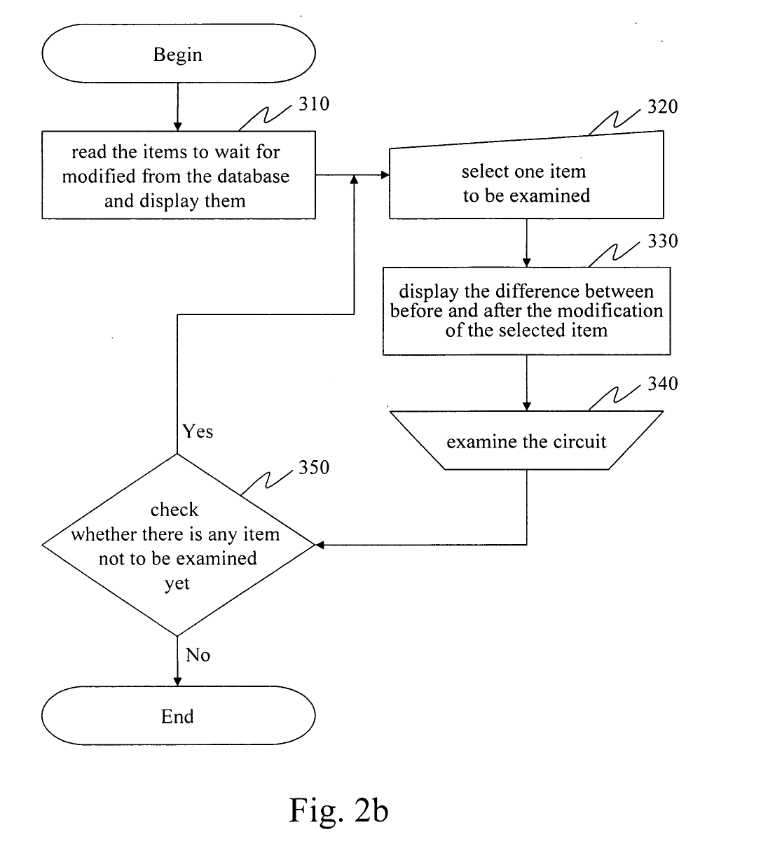

Then, the operation flow of the method of the present invention is illustrated through the flow chart of the main method for automatically indicating items to wait for modified according to the present invention as shown in FIG. 2a. When the present invention is to be used by a user, first, the items to wait for modified are stored in the data storage module 130 (Step 210). The display module 150 reads the items to wait for modified from the data storage module 130 and the displays the readout items to wait for modified (Step 220). Then, an item having not been modified completely is selected from the readout items to wait for modified, then the selected item is modified (Step 230). The display module 150 marks the parts to be modified according to the modification information recorded in the selected item to wait for modified (Step 240). Then, the circuit is modified according to the marked parts (Step 250). After the circuit has been modified, the displaying module 150 sends the modification information of the modified item to the amendment check module 160, and the amendment check module 160 checks whether the item has been completely modified or not according the modification information sent from the display module 150 (Step 260). If no, a modification information of the parts having not been modified completely is generated, and then the generated modification information is sent back to the display module 150, and after the display module 150 received the modification information, the parts that need to be modified will be marked out again; if the amendment check module 160 checks that the item has been completely modified, the display module 150 will further check whether there is any item having not been modified completely in the items readout from the data storage module 130 (Step 270). If no, another item to wait for modified will be selected to be modified.

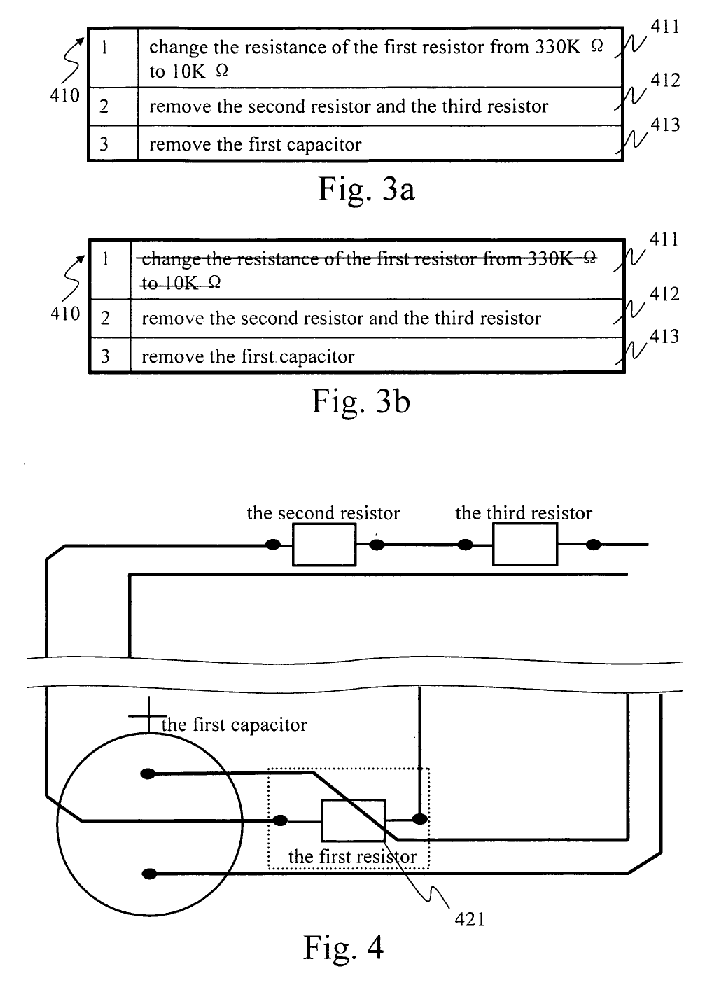

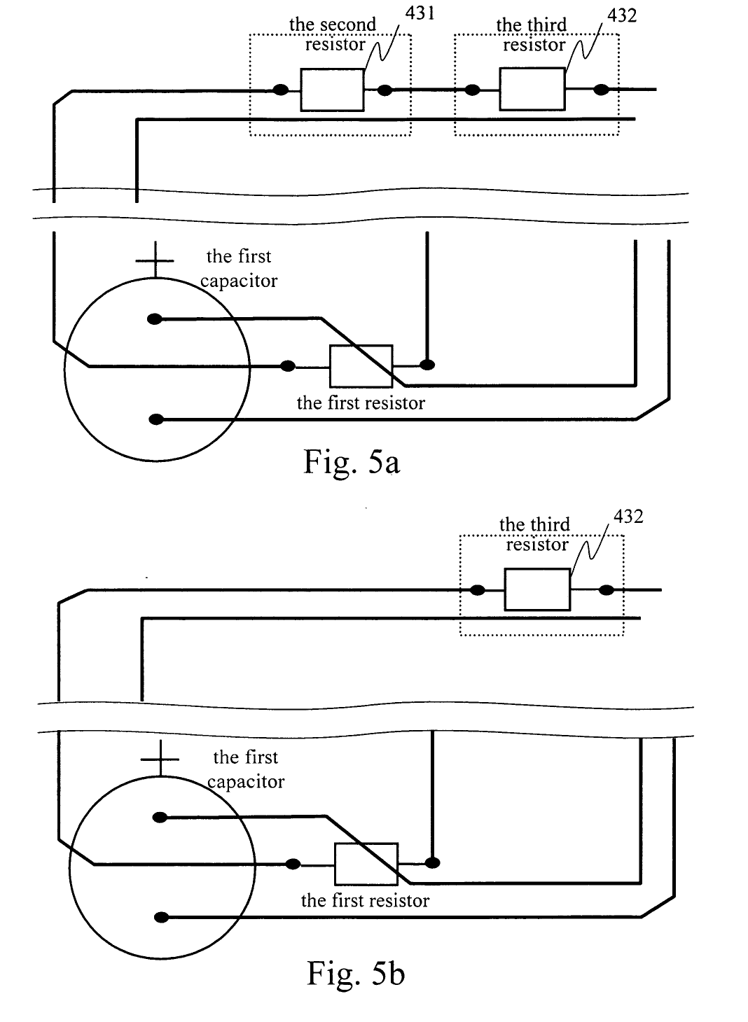

Then, the operation system and method of the present invention will be demonstrated through one embodiment. The circuit designer intends to modify the circuit diagram through the circuit layout software. When using the present invention, three items to wait for modified are stored into the database, wherein the first item to wait for modified is changing the resistance of a first resistor from 330 KΩ to 10 KΩ; the second is removing a second resistor and a third resistor; and the third is removing a first capacitor. As shown in FIG. 3a, a list 410 of three items to wait for modified is displayed on the circuit layout software. Then, as shown in FIG. 4, after the designer selects the first item to wait for modified 411, the first resistor 421 is marked by adding dashed frame thereon via the circuit layout software. Then, the designer conveniently finds that the first resistor 421 added with the dashed frame is the part need to be modified, which is also indicated by the list 410 displaying the items to wait for modified (FIG. 3a), and the first resistor 421 will be changed to 10 KΩ. Then, through the circuit layout software, the list 410 displaying the items to wait for modified will display the first item 411 with a strikeout, while the second item 412 and the third item 413 are in the normal display state (FIG. 3b). Continue referring to FIGS. 5a and 5b, the designer selects the second item 412 to make modification, and conveniently finds a second resistor 431 and a third resistor 432 added with dashed frames, and then removes the second resistor 431. After removing the second resistor 431, the third resistor 432 is neglected, and the user selects the third item 413 to make modification. The circuit layout software finds that the third resistor 432 hasn't been modified completely, and adds the dashed frame to the third resistor 432 to indicate the designer again. If the designer indeed wants to modify the third item 413, the list 410 for displaying the items to wait for modified still only displays the first item 411 with the strikeout, while the second item 412 and the third item 413 are displayed with the normal state (FIG. 3b). Therefore, the designer will not neglect parts that need to be modified.

Back to FIG. 1, the system of the present invention further comprises an analysis transformation module 120, and a modification suggestion module 140. The analysis transformation module 120 is used for analyzing the input amendment list 110 and generating the items to wait for modified. The generated items are stored in the data storage module 130. The modification suggestion module 140 is used for obtaining the items to wait for modified from the display module 150 and generating the modification suggestion of the item to wait for modified. Besides the two newly-added modules, the original display module 150 is additionally used for obtaining the modification record of the items to wait for modified, displaying the difference between before and after the modification of the item to wait for modified, and checking whether there is still any item in the items to wait for modified that has not been examined completely.

Accordingly, the operation flow of the method of the present invention illustrated through the flow chart of the main method for automatically indicating the item to wait for modified according to the present invention in FIG. 2a is varied as follows: in step 210, the items to wait for modified stored in the data storage module 130 are generated after the analysis transformation module 120 analyzes the input amendment list 110; in step 240, the display module 150 displays the modification suggestions generated by the modification suggestion module 140, besides marking the parts that need to be modified according to the modification information recorded in the selected item to wait for modified. Besides the above changes, the flow of examining the items to wait for modified is further added. The operation flow of the examining process added to the method of the present invention is further illustrated through the flow chart of the examining method for automatically indicating the items to wait for modified of the present invention shown in FIG. 2b. When the user intends to examine the items to wait for modified through the present invention, the display module 150 reads the items to wait for modified stored in the data storage module 130 and displays the readout items to wait for modified (Step 310). Then, an item having not been modified completely is selected from the readout items to wait for modified to be examined (Step 320). The display module 150 marks the difference between before and after the modification of the selected item to wait for modified according to the modification records (Step 330). And the circuit can be examined according to the marked parts (Step 340). After the circuit has been examined, the display module 150 will check whether there is any item in the readout items to wait for modified not to be examined yet (Step 350); if no, another item to wait for modified will be selected to be examined.

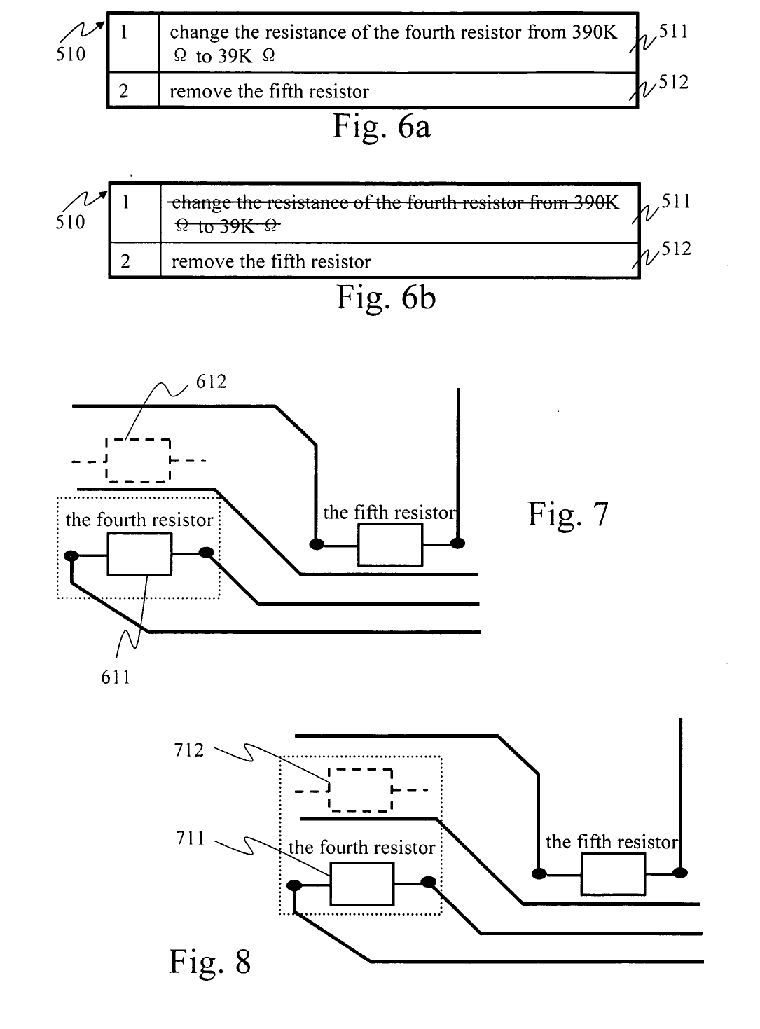

Then, the additional operation system and method of the present invention will be further illustrated through another embodiment. The circuit designer intends to modify the circuit diagram with the circuit layout software according to an amendment list having the following two contents: the first is to change a fourth resistor from 390 KΩ to 39 KΩ, and the other is to remove a fifth resistor. As shown in FIG. 6a, the designer inputs the amendment list to the circuit layout software through the present invention. Then, the circuit layout software generates two items to wait for modified stored in the database, and displays a list 510 of the input items. Then, referring to FIG. 7, after the first item to wait for modified 511 is selected, besides finding the fourth resistor 611 of 390 KΩ added with dashed frame being the part that needs to be modified, the designer also finds a resistor 612 of 39 KΩ appears above the fourth resistor 611 by way of dashed lines through the circuit layout software, which is the modification suggestion. Back to FIG. 6a, after the modification of the two items to wait for modified in the amendment list has finished, the designer intends to examine whether the modification is correct or not. Then, the two items to wait for modified will be readout via the circuit layout software from the database, and the list 510 is displayed. As shown in FIG. 8, when the designer selects the first item 511 to examine, the original resistor 712 of 390 KΩwill be displayed above the modified fourth resistor 711 of the 39 KΩ by way of dashed lines through the circuit layout software, and the fourth resistor 711 after modification and the fourth resistor 712 before modification are depicted together with a dashed frame, for examining convenience. After that, the designer will select the second item 512 to examine. Meanwhile, as for the items to wait for modified displayed via the circuit layout software, the first item 511 is displayed with a strikeout, and the second item 512 is displayed in the normal state (FIG. 6b), such that the designer knows which part has already been examined.

The invention being thus described, it will be obvious that the same may be varied in many ways. Such variations are not to be regarded as a departure from the spirit and scope of the invention, and all such modifications as would be obvious to one skilled in the art are intended to be comprised within the scope of the following claims.

What is claimed is:

1. A circuit layout system for automatically indicating items to wait for modified, wherein at least one item to wait for modified are read into a piece of circuit layout software so as to achieve automatic indication of the items to wait for modified, comprising:
a data storage module, for storing the item to wait for modified;
an amendment check module, for receiving a modification information of an item to wait for modified, and checking whether the item to wait for modified has been completely modified according to the modification information, and sending a modification information with respect to the parts having not been completely modified when the item to wait for modified has not been completely modified; and
a display module, for reading the items to wait for modified from the data storage module, displaying them, marking the parts that needs to be modified according to the modification information of the items to wait for modified, sending the modification information of the item to wait for modified into the amendment check module, receiving the modification information from the amendment check module, and marking the parts having not been modified completely according to the non-modification information so as to checking whether there is any item having not been modified completely in the items to wait for modified.

2. The circuit layout system for automatically indicating items to wait for modified according to claim 1, wherein after the amendment check module checks that the item to wait for modified has been modified, the difference between before and after the modification is stored in the modification record of the corresponding item to wait for modified in the data storage module.

3. The circuit layout system for automatically indicating items to wait for modified according to claim 1, wherein the system further comprises an analysis transformation module for analyzing an amendment list, and storing the item to wait for modified generated after the analysis into the data storage module.

4. The circuit layout system for automatically indicating items to wait for modified according to claim 1, wherein the display module is further used for reading the modification record of the items to wait for modified from the data storage module, displaying the difference between before and after the modification of the item to wait for modified, and checking whether there is any item to wait for modified having not been examined completely in the items to wait for modified.

5. The circuit layout system for automatically indicating items to wait for modified according to claim 1, wherein the data storage module is further used for storing a circuit layout rule.

6. The circuit layout system for automatically indicating items to wait for modified according to claim 5, wherein the system further comprises a modification suggestion module, for reading the circuit layout rule and the modification information of the item to wait for modified from the data storage module according to the item to wait for modified displayed by the display module, generating and sending out a modification suggestion after analyzing the modification information according to the circuit layout rule.

7. The circuit layout system for automatically indicating items to wait for modified according to claim 6, wherein the display module is further used for receiving the modification suggestion generated by the modification suggestion module and displaying the modification suggestion.

8. A circuit layout method for automatically indicating items to wait for modified, wherein a plurality of items to wait for modified are reading via a piece of circuit layout software to achieve the automatically indication of the items to wait for modified, comprising:
(a) reading the items to wait for modified from a database and displaying them;
(b) selecting an item having not been modified completely from the items to wait for modified for modification, and obtaining the modification information of the item to wait for modified;
(c) marking the parts that need to be modified in the item to wait for modified according to the modification information of the item to wait for modified;
(d) checking whether the item to wait for modified has been completely modified or not according to the modification information of the modified item and generating a checking result, after the item to wait for modified has been completely modified; and
(e) checking whether there is any item to wait for modified that has not been completely modified.

9. The circuit layout method for automatically indicating items to wait for modified according to claim 8, wherein if the checking result in step (d) is yes, store a modification record of the difference between before and after modification in the item to wait for modified of the database.

10. The circuit layout method for automatically indicating items to wait for modified according to claim 8, wherein the checking result in step (d) is no, generate a non-modification information of parts having not been modified completely, and return to step (c) to mark the part that needs to be modified.

11. The circuit layout method for automatically indicating items to wait for modified according to claim 8, wherein if the checking result in step (e) is yes, return to step (b).

12. The circuit layout method for automatically indicating items to wait for modified according to claim 8, wherein the method further comprises a step (a-1) in step (a), for analyzing an amendment list and storing the of modification data generated after analysis into the database.

13. The circuit layout method for automatically indicating items to wait for modified according to claim 8, wherein the method further comprise a step (f), for selecting an item to wait for modified from the items to wait for modified for being examined, displaying the parts that need to be modified according to the item to wait for modified, and displaying the difference between before and after the modification of the item to wait for modified according to the modification record of the item to wait for modified.

14. The circuit layout method for automatically indicating items to wait for modified according to claim 13, wherein the method further comprises a step (g) after step (f), for checking whether there is any item to wait for modified which has not been examined yet after examining the item to wait for modified, and if there is any item to wait for modified which has not been examined yet, return to step (f).

15. The circuit layout method for automatically indicating items to wait for modified according to claim 8, wherein step (c) further comprises a step (c-1), for displaying an modification suggestion obtained after analyzing the circuit layout rule stored in the database base on the modification information of the item to wait for modified.

16. The circuit layout method for automatically indicating items to wait for modified according to claim 15, wherein in step (c-1), displaying the modification suggestion after analyzing is set as no function.
